(19) United States
(12) Patent Application Publication
(10) Pub. No.: US 2008/0116802 A1
(43) Pub. Date: May 22, 2008

(54) PLASMA DISPLAY PANEL AND METHOD OF FORMING A BARRIER RIB THEREOF

(75) Inventor: Koichi Sakita, Hyogo (JP)

Correspondence Address: STAAS & HALSEY LLP, SUITE 700, 1201 NEW YORK AVENUE, N.W., WASHINGTON, DC, 20005, US

(73) Assignee: Fujitsu Hitachi Plasma Display Limited, Miyazaki (JP)

(21) Appl. No.: 11/754,429

(22) Filed: May 29, 2007

(30) Foreign Application Priority Data
Nov. 21, 2006 (JP) 2006-314589

(51) Int. Cl. H01J 17/49; H01J 9/00

(52) U.S. Cl. 313/584; 445/24

(57) ABSTRACT

A plasma display panel includes a pair of substrates forming a discharge space therebetween, barrier ribs in a row direction and a column direction that divide the discharge space to form discharge cells in a matrix pattern, and phosphor layers of three colors of red, green and blue formed inside the discharge cells to provide different colors through repetitive patterns. The phosphor layers have the same color in the discharge cells in the column direction. The width of barrier ribs that divide discharge cells having a red phosphor layer whose luminosity factor is the smallest is made wider than that of barrier ribs that divide discharge cells of the other colors so that the height of the barrier ribs is made lower.

### CROSS-REFERENCE TO RELATED APPLICATION

This application is related to Japanese application No. 2006-314589 filed on Nov. 21, 2006 whose priority is claimed under 35 U.S.C. §119, the disclosure of which is incorporated by reference in its entirety.

### BACKGROUND OF THE INVENTION

1. Field of the Invention

This invention relates to a plasma display panel (hereinafter, referred to as “PDP”) and a method of forming barrier ribs thereof, and more particularly, relates to a PDP in which barrier ribs (ribs) of a closed type that divide a discharge space into respective cells are installed between a pair of substrates forming a panel and a method of forming such barrier ribs.

2. Description of the Related Art

An AC drive three-electrode surface discharge type PDP has been known as a conventional PDP. This PDP has a structure in which desired constituent elements such as electrodes, dielectric layers, phosphor layers and barrier ribs are formed on glass substrates on the front-face side and the back-face side and these glass substrates on the front-face side and the back-face side are bonded to each other. The sealing process of the front-side substrate and the back-side substrate is carried out through the following processes: a glass sealing material containing low-melting point glass is applied to the peripheral portion of the substrates and the glass sealing material is melted by heat so that the substrates are adhered and bonded to each other. In this bonding process, a vacuum-exhausting process is carried out on the inside of the panel through a vent pipe formed in the substrate on the back-face side into a low pressure so that, after impurity gases have been once removed, an inert gas such as Ne and Xe is then sealed therein as a discharge gas.

The structure of the barrier ribs includes, for example, a linear barrier-rib structure (referred to as a stripe rib structure) in which a discharge space is separated only in the row direction by forming a plurality of barrier ribs in the column direction, and a closed-type barrier-rib structure (referred to as a box rib structure, a waffle rib structure, a mesh rib structure, or the like) in which the discharge space is divided into respective cells by forming barrier ribs in the row direction and barrier ribs in the column direction (see Japanese Unexamined Patent Publication No. 2002-163990). In recent years, in order to provide pixel with high definition, there has been strong a demand for PDPs having the closed-type barrier-rib structure.

As described above, in the manufacturing process of the PDP, impurity gases need to be removed from the inside of the panel by carrying out a vacuum exhausting operation through a vent pipe. In this case, the PDP having the closed-type structure of barrier ribs has a smaller ventilation conductance in the panel in comparison with the PDP having the linear structure of barrier ribs, resulting in a difficulty in exhausting the impurity gases. When the removal of the impurity gases is insufficient, the characteristics of the panel deteriorate. More specifically, there are a reduction in the brightness and variations in the voltage due to degradation of the phosphor, and display irregularities in the panel tend to be caused.

For this reason, various structures for barrier ribs, used for improving the vent (exhaust) path inside the panel, have been proposed. For example, a structure has been known in which, of the barrier ribs in the row direction and the barrier ribs in the column direction, only the barrier ribs in the row direction are made lower so that the vent path is expanded. In this case, however, since the manufacturing processes become complicated, there has been a demand for a method for ensuring a vent path of the PDP having the closed-type structure of barrier ribs by using a simpler structure.

### SUMMARY OF THE INVENTION

The present invention, which has been devised to solve the above-mentioned problems, has a structure in which, by taking it into account that the height of barrier ribs vary depending on thermal shrinkage, the width of barrier ribs that separate a red phosphor layer whose luminosity factor is the smallest is made wider than that of barrier ribs that divide phosphor layers of the other colors so that the height of the corresponding barrier ribs after the firing process is made lower; thus, it becomes possible to improve the ventilation inside the panel in the PDP having barrier ribs of the closed-type structure.

The present invention provides a plasma display panel comprising: a pair of substrates forming a discharge space therebetween; barrier ribs in a row direction and a column direction that divide the discharge space into the row direction and the column direction to form discharge cells in a matrix pattern; and phosphor layers of three colors of red, green and blue formed inside the discharge cells to provide different colors through repetitive patterns and also to have the same color in the discharge cells in the column direction, wherein the width of barrier ribs that divide discharge cells having a red phosphor layer whose luminosity factor is the smallest is made wider than that of barrier ribs that divide discharge cells of the other colors so that the height of the barrier ribs is made lower.

In accordance with the present invention, since the height of barrier ribs dividing red discharge cells is made lower, it is possible to form a gap between the top portion of the barrier ribs and the opposing substrate when bonding the substrate having closed-type barrier ribs formed thereon to the opposing substrate to carry out a vacuum-exhausting process, and this gap is used as a vent path through which impurity gases are discharged. With this arrangement, since the exhausting process of impurity gases inside the cells surrounded by the barrier ribs can be carried out sufficiently, it becomes possible to provide a PDP having high reliability with high quality.

### BRIEF DESCRIPTION OF THE DRAWINGS

FIGS. 1(a) and 1(b) are explanatory diagrams that show a structure of a PDP in accordance with an embodiment of the present invention;

FIG. 2 is an explanatory diagram that shows the back-face side of the PDP of an embodiment of the present invention;

FIG. 3 is a perspective view that shows barrier ribs having a lattice pattern formed on the substrate on the back-face side of the PDP of an embodiment of the present invention;

FIGS. 4(a) to 4(d) are explanatory diagrams that show a first embodiment of barrier ribs of the present invention;

FIGS. 5(a) to 5(d) are explanatory diagrams that show a second embodiment of barrier ribs of the present invention;

FIG. 6 is an explanatory diagram that shows a third embodiment of barrier ribs of the present invention;

FIG. 7 is an explanatory diagram that shows a fourth embodiment of barrier ribs of the present invention;

FIGS. 8(a) to 8(c) are explanatory diagrams that show a first comparative example; and

FIGS. 9(a) and 9(b) are explanatory diagrams that show a second comparative example.

### DETAILED DESCRIPTION OF THE INVENTION

In the present invention, the substrates include substrates of materials such as glass, quartz and ceramics, and also include substrates prepared by forming desired constituent elements such as electrodes, an insulating film, a dielectric layer, a protective film and the like on these substrates.

The above-mentioned electrodes can be formed by using various materials and methods known in the corresponding field. With respect to materials used for the electrodes, for example, transparent conductive materials such as ITO and SnO₂ and metal conductive materials such as Ag, Au, Al, Cu and Cr are used. With respect to the formation method of the electrodes, various methods known in the corresponding field may be used. For example, a thick-film forming technique such as printing may be used, or a thin-film forming technique using a physical deposition method or a chemical deposition method may be used. With respect to the thick-film forming technique, for example, a screen printing method is listed. In the thin-film forming technique, the physical deposition method includes a vapor deposition method, and a sputtering method. The chemical deposition method includes a thermal CVD method, a photo CVD method and a plasma CVD method.

In the present invention, “the closed-type barrier ribs” refer to barrier ribs having a structure in which a discharge space is divided into respective cells. These barrier ribs include barrier ribs of a lattice-shaped structure that is configured by barrier ribs formed on a panel surface in the row direction and barrier ribs formed thereon in the column direction, that is, a so-called box-rib structure, a waffle-rib structure, a mesh-rib structure, or the like. In this case, the barrier ribs in the row direction and the barrier ribs in the column direction are not necessarily required to be made orthogonal to each other, as long as they are made to cross each other at a desired angle. The height of the barrier ribs in the row direction and the height of the barrier ribs in the column direction are not necessarily made equal, and may be set to different heights. In addition to these, the closed-type barrier ribs in accordance to the present invention may include barrier ribs of a so-called meander rib structure in which by forming barrier ribs in a winding pattern, the discharge space is virtually divided into respective cells.

The barrier ribs of the closed type are formed through the following processes: a material layer for barrier ribs is formed on a substrate, and the material layer for barrier ribs is patterned into a barrier-rib form of the closed type, and the patterned layer of the barrier-rib form is fired. More specifically, the barrier ribs of the closed type can be formed by a sand blasting method, a photo-etching method or the like. For example, in the sand blasting method, a glass paste, made from glass frit, a binder resin, a solvent and the like, is applied onto a substrate and dried thereon so that a material layer for barrier ribs is formed, and cutting particles are blasted onto the material layer for the barrier ribs, with a cutting mask having openings corresponding to the pattern of the barrier ribs attached thereto, and the material layer for the barrier ribs exposed to the openings of the mask is cut so that a barrier-rib shaped layer is formed, and the resulting layer is fired so that barrier ribs are formed. Moreover, in the photo-etching method, instead of the cutting process by the use of cutting particles, a photosensitive resin is used as the binder resin, and a barrier-rib shaped layer is formed through exposing and developing processes by the use of a mask, and by firing the resulting layer, the barrier ribs are formed.

In the PDP in accordance with the present invention, a discharge space is divided by barrier ribs in a row direction and barrier ribs in a column direction to form discharge cells in a matrix pattern, with phosphor layers of three colors of red, green and blue being formed inside the discharge cells so as to provide different colors through repetitive patterns and also to have the same color in the discharge cells in the column direction.

In the present invention, the width of barrier ribs that divide discharge cells having a red phosphor layer whose luminosity factor is the smallest is made wider than that of barrier ribs that divide discharge cells having phosphor layers of the other colors so that the height of the corresponding barrier ribs is made lower.

The barrier ribs used for dividing the red discharge cells, which are made to have a lower height with a wider width, may be prepared as the barrier ribs in the row direction, or may be prepared as the barrier ribs in the column direction.

Moreover, the present invention provides a method of forming barrier ribs of a plasma display panel in which: a material layer for barrier ribs is formed on one of substrates, and the material layer for barrier ribs is patterned into a barrier-rib form of the closed type in which the discharge space is separated into R cells used for forming a red phosphor layer, G cells used for forming a green phosphor layer and B cells used for forming a blue phosphor layer, and during the patterning process, a barrier-rib forming layer having a pattern that makes the width of barrier ribs in the row direction or the width of barrier ribs in the column direction used for separating the R cells wider than the width of barrier ribs used for separating the cells having another color is formed so as to make the height of the barrier ribs in the row direction or the barrier ribs in the column direction of the barrier ribs separating the R cells irregular through thermal shrinkage at the time of firing, and by firing the barrier-rib forming layer, barrier ribs of the closed-type that make the height of the barrier ribs in the row direction or the barrier ribs in the column direction used for separating the R cells lower than that of the barrier ribs used for separating the G cells and B cells.

Referring to embodiments shown in the drawings, in the following description, the present invention will be discussed in detail. However, the present invention is not limited thereto, and various modifications may be made therein.

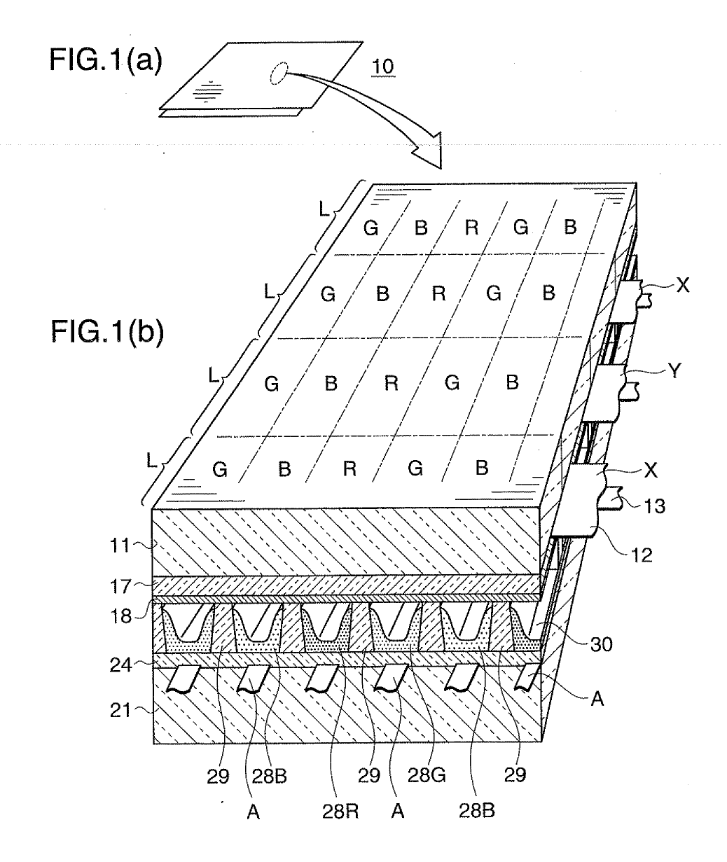

FIGS. 1(a) and 1(b) are explanatory diagrams that show a structure of a PDP in accordance with an embodiment of the present invention. FIG. 1(a) shows the entire structure of the PDP, and FIG. 1(b) is a partially exploded perspective view of the PDP. This PDP is a three-electrode surface discharge type PDP of an AC drive type for color display.

The PDP 10 is constituted by a substrate 11 on the front-face side on which constituent elements that provide functions as the PDP are formed and a substrate 21 on the back-face side. With respect to the substrate 11 on the front-face side and the substrate 21 on the back-face side, glass substrates are used; however, in addition to the glass substrates, for example, quartz substrates and ceramics substrates may be used.

Display electrodes X and display electrodes Y are placed with equal intervals in the horizontal direction on the inner side face of the substrate 11 on the front-face side. All the intermediate portions between the adjacent display electrodes X and display electrodes Y form display lines L. Each of the display electrodes X and Y is constituted by a transparent electrode 12 with a wide width, made of ITO, SnO₂ or the like, and a bus electrode 13 with a narrow width, made of metal, such as Ag, Au, Al, Cu, Cr or a laminated body thereof (for example, Cr—Cu—Cr laminated structure). With respect to the display electrodes X and Y, in the case of Ag and Au, a thick-film forming technique such as screen printing may be used, and in the case of other materials, a thin-film forming technique, such as a vapor deposition method and a sputtering method, and an etching technique may be used, so that the display electrodes having a desired number, thickness, width and intervals are formed.

Here, in the present PDP, a PDP having a so-called ALIS structure, in which the display electrodes X and the display electrodes Y are placed with equal intervals, with all the intermediate portions between the adjacent display electrodes X and display electrodes Y forming display lines L, is shown; however, the present invention may be applied even to a PDP having a structure in which paired display electrodes X and Y are placed with a gap (non-discharging gap) causing no discharge.

A dielectric layer 17 is formed on the display electrodes X and Y in a manner so as to cover the display electrodes X and Y. The dielectric layer 17 is formed by applying a glass paste made from glass frit, a binder resin and a solvent onto a substrate 11 on the front-face side through a screen printing method and by firing the resulting substrate. The dielectric layer 17 may be prepared by forming a SiO₂ film through a plasma CVD method.

A protective film 18, used for protecting the dielectric layer 17 from damage caused by collision of ions generated by a discharge in displaying, is formed on the dielectric layer 17. This protective film is made of MgO. The protective film may be formed by using a known thin-film forming process in the corresponding field, such as an electron beam vapor deposition method and a sputtering method.

A plurality of address electrodes A are formed on the inner side face of the substrate 21 on the back-face side in a direction crossing the display electrodes X and Y when viewed from above, and a dielectric layer 24 is formed to cover the address electrodes A. Each of the address electrodes A is used for generating an address discharge so as to select a light-emitting cell at an intersection with the Y electrode, and formed into a three-layer structure of Cr—Cu—Cr. The address electrodes A may be formed by using another material such as Ag, Au, Al, Cu, or Cr. In the same manner as with the display electrodes X and Y, with respect to the address electrodes A, in the case of Ag and Au, a thick-film forming technique such as screen printing may be used, and in the case of other materials, a thin-film forming technique such as a vapor deposition method and a sputtering method, and an etching technique may be used, so that the address electrodes having a desired number, thickness, width and intervals are formed. The dielectric layer 24 may be formed by using the same material and the same method as the dielectric layer 17.

Closed-type barrier ribs 29 that divide a display space into respective discharge cells (hereinafter, referred to as cells), that is, barrier ribs 29 having a lattice pattern, are formed on the dielectric layer 24 between the adjacent address electrodes A. The barrier ribs 29 having the lattice pattern are also referred to as box ribs, waffle ribs and mesh-shaped ribs. The barrier ribs 29 may be formed by using a method such as a sand blasting method and a photo-etching method. For example, in the sand blasting method, a glass paste made from glass frit, a binder resin, a solvent and the like, is applied onto the dielectric layer 24 and dried thereon, and cutting particles are then blasted onto the glass paste layer, with a cutting mask having openings corresponding to the pattern of the barrier ribs attached thereto so that the glass paste layer exposed to the openings of the mask are cut, and the resulting layer is further subjected to a firing process so that barrier ribs are formed. Moreover, in the photo-etching method, instead of the cutting process by the use of cutting particles, a photosensitive resin is used as the binder resin, and after carrying out the exposing and developing processes by the use of a mask, the resulting layer is fired so that the barrier ribs are formed.

Phosphor layers of 28R, 28G and 28B having red (R), green (G) and blue (B) colors respectively are formed on side faces and a bottom face of each of cells having a rectangular shape when viewed from above, which is surrounded by barrier ribs 29 having a lattice pattern. The phosphor layers 28R, 28G and 28B are formed through processes in which: a phosphor paste containing phosphor powder, a binder resin and a solvent is applied to the inside of each cell surrounded by the barrier ribs 29 by using a screen printing method or a method using a dispenser, and after repeating this process for each of the colors, the resulting layers are fired. These phosphor layers 28R, 28G and 28B may also be formed through a photolithographic technique by using a sheet-shaped phosphor layer material (so-called green sheet) containing phosphor powder, a photosensitive material and a binder resin. In this case, a sheet having a desired color is affixed to the entire face of a display area on the substrate, and this is exposed and developed, and by repeating these processes for each of the colors, the phosphor layers of the respective colors are formed in the corresponding cells.

A PDP is manufactured through the following processes: the above-mentioned substrate 11 on the front-face side and substrate 21 on the back-face side are placed face to face with each other so that the display electrodes X and Y cross the address electrodes A, and the peripheral portion is sealed with a discharge space 30 surrounded by the barrier ribs 29 being filled with a discharge gas containing Xe and Ne in a mixed state. In this PDP, the discharge space 30, located each of the intersections between the display electrodes X and Y and the address electrodes A, forms one cell (unit light-emitting area) that is the minimum unit for display. One pixel is configured by three cells of R, G and B.

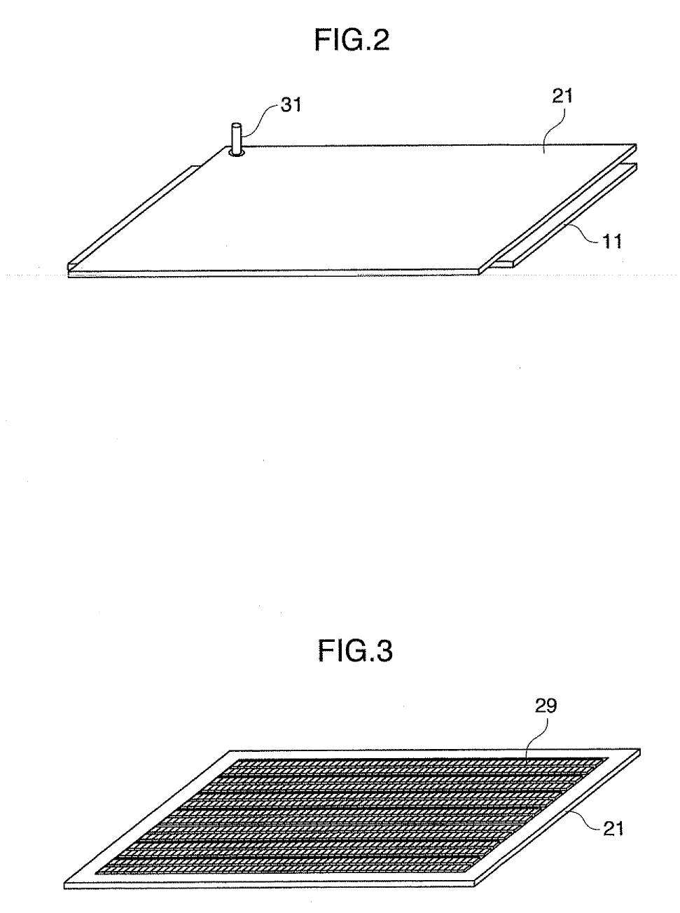

FIG. 2 is an explanatory diagram that shows the PDP on the back-face side of an embodiment of the present invention.

In forming the substrate 11 on the front-face side and the substrate 21 on the back-face side, a paste-form glass sealing material containing glass frit, a binder resin, a solvent and the like is applied to a portion on the periphery of a substrate to be sealed, and this is temporarily fired to burn and eliminate the resin component. Then, the substrate 11 on the front-face side and the substrate 21 on the back-face side are placed face to face with each other so that the display electrodes and address electrodes are made to cross each other, and the glass sealing material is fused by applying heat so that the substrates are anchored and bonded to each other.

In this bonding process, a vacuum-exhausting process is carried out on the inside of the panel through a vent pipe 31 formed in the substrate 21 on the back-face side to a low pressure so that, after impurity gases have been once removed, a discharge gas formed by mixing Xe and Ne is then sealed therein.

FIG. 3 is a perspective view that shows barrier ribs having a lattice pattern formed on the substrate on the back-face side of the PDP.

As shown in this figure, barrier ribs 29 having a lattice pattern are formed on a substrate 21 on the back-face side. These lattice-shaped barrier ribs 29 are configured by barrier ribs in the row direction and barrier ribs in the column direction so that a discharge space is divided into rectangular areas by the barrier ribs in the row direction and the barrier ribs in the column direction when viewed from above. Each cell area divided by the lattice-shaped barrier ribs 29 has a rectangular shape when viewed from above; however, the shape of the cell is not limited by this shape, and various shapes may be used with the cell.

In the following description, specific embodiments of the barrier ribs will be discussed.

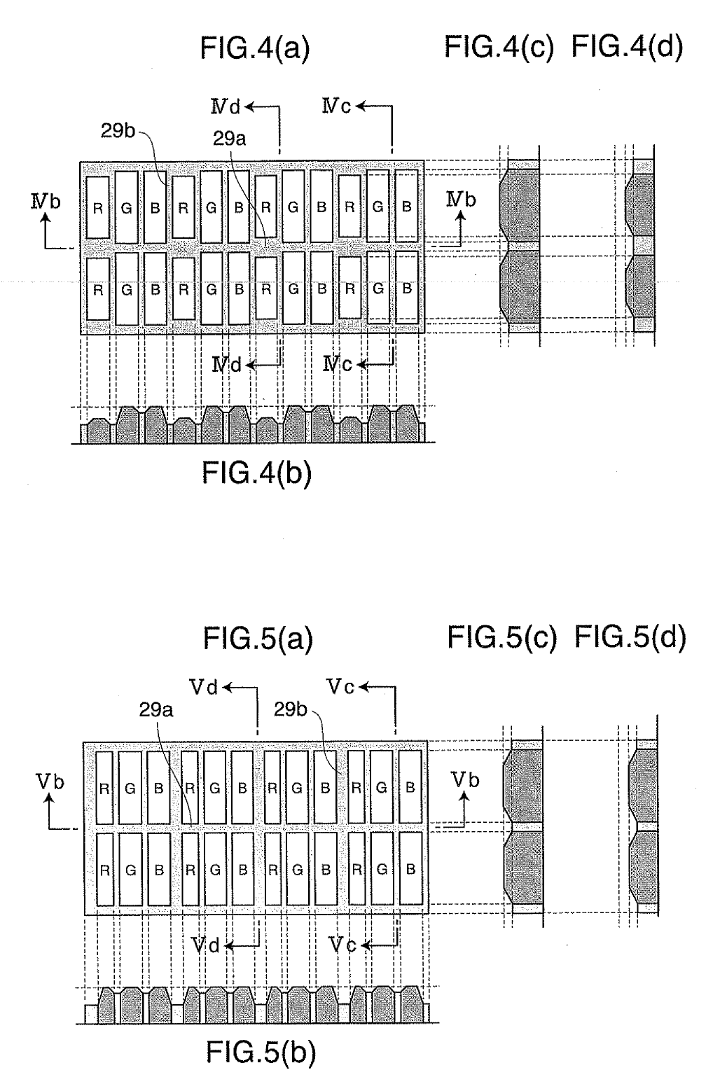

FIGS. 4(a) to 4(d) are explanatory diagrams that show a first embodiment of the barrier ribs according to the present invention. FIG. 4(a) shows a state in which barrier ribs are viewed from above; FIG. 4(b) is a cross-sectional view taken along line IVb-IVb of FIG. 4(a); FIG. 4(c) is a cross-sectional view taken along line IVc-IVc of FIG. 4(a); and FIG. 4(d) is a cross-sectional view taken along line IVd-IVd of FIG. 4(a).

The barrier ribs correspond to lattice-shaped barrier ribs 29 formed by barrier ribs 29a in the row direction and barrier ribs 29b in the column direction, and a discharge space is divided by these lattice-shaped barrier ribs 29 into R cells used for forming a red phosphor layer, G cells used for forming a green phosphor layer and B cells used for forming a blue phosphor layer.

In these lattice-shaped barrier ribs 29, a portion having a thick barrier-rib width is formed on each of the barrier ribs 29a in the row direction that separate the R cells. The barrier-rib width of each of the barrier ribs 29b in the column direction is constant without any portion having a thick barrier-rib width.

The cell areas are made to have the same size with respect to the G cell area and the B cell area; however, the R cell area is made narrower in the longitudinal direction in the figure, in comparison with the G cell area and the B cell area. In this structure, although the discharge space in the R cell becomes smaller, no adverse effect is given on full color display because the red phosphor has a smaller luminosity factor in comparison with those of the green and blue phosphors (that is, the smallest).

The process for forming the portion having a thick barrier-rib width on each barrier rib 29a in the row direction that separates the R cells is carried out as follows: after a material layer for barrier ribs has been formed on the substrate on the back-face side, the portion having a thick barrier-rib width is formed, when patterning the material layer for barrier ribs.

The patterning process of the material layer for barrier ribs is carried out by a sand blasting method. In the sand blasting method, a glass paste, made from glass frit, a binder resin, a solvent and the like, is applied onto a substrate and dried thereon so that a material layer for barrier ribs is formed. Next, cutting particles are blasted onto the material layer for the barrier ribs, with a cutting mask having openings corresponding to the pattern of the barrier ribs attached thereto, and the material layer for the barrier ribs exposed to the openings of the mask is cut so that a barrier-rib shaped layer is formed, and the resulting barrier-rib shaped layer is fired so that barrier ribs are formed. In this case, the cutting mask is formed through processes in which after a photosensitive dry film resist has been laminated on a substrate, the resulting substrate is exposed through a photo-mask, and then developed. The barrier ribs may be formed by a photo-etching method, and in the case of using the photo-etching method, instead of the cutting process by the use of cutting particles, a photosensitive resin is used as the binder resin, and a barrier-rib shaped layer is formed through exposing and developing processes by the use of a mask, and by firing the resulting layer, the barrier ribs are formed.

In the case where the barrier-rib shaped layer is fired, since the portion having the thick barrier-rib width is formed on the barrier-rib shaped layer, the heights of the barrier ribs are formed irregularly upon firing due to thermal shrinkage caused by this structure.

In the figures, since the width of each barrier rib in the row direction separating the R cells is made thicker, the height of each of the barrier ribs in the row direction separating the respective R cells becomes lower due to thermal shrinkage at the time of firing. Moreover, the crossing portion between the barrier rib in the row direction and the barrier rib in the column direction becomes further lower than the above-mentioned height.

These irregularities on the top portions of the barrier ribs, caused by thermal shrinkage of the material for the barrier ribs, are dependent on the shapes of the barrier ribs and the rate of thermal shrinkage of the material for the barrier ribs. Consequently, it is difficult to theoretically predict what irregularities are formed on the top portions of the barrier ribs after the firing process; however, in general, the height of the barrier ribs tends to become lower at portions in which the barrier rib in the row direction and the barrier rib in the column direction cross each other, as well as at portions in which the width of the barrier ribs is made wider.

In the sealing process for sealing the peripheral portions of the substrate on the front-face side and the substrate on the back-face side, after a glass sealing material has been applied to a portion to be sealed on the periphery of the substrate on the back-face side, and then temporarily fired, the substrate on the back-face side and the substrate on the front-face side are made face to face with each other, and in this state, the two substrates are air-tightly bonded to each other through a heating process. In this heating process, while the glass sealing material is heated to be fused, air is drawn out through a vent pipe formed in the substrate on the back-face side so that a negative pressure is exerted inside the PDP; thus, impurity gases are discharged from the inside of the PDP, and the discharge space inside the PDP is successively filled with a discharge gas. At this time, a gap formed between the portion of the barrier rib having a lower height and the substrate on the front-face side serves as a vent path.

As described above, a portion having a thick barrier-rib width is formed on the barrier-rib shaped layer that separates the red phosphor layer having the minimum luminosity factor so that the heights of barrier ribs are made irregular due to thermal shrinkage at the time of firing; thus, it is possible to ensure a vent path used during sealing the substrates, and consequently to sufficiently carry out an exhausting process of impurity gases and an injecting process of a discharge gas.

FIGS. 5(a) to 5(d) are explanatory diagrams that show a second embodiment of the barrier ribs according to the present invention. FIG. 5(a) shows a state in which barrier ribs are viewed from above; FIG. 5(b) is a cross-sectional view taken along line Vb-Vb of FIG. 5(a); FIG. 5(c) is a cross-sectional view taken along line Vc-Vc of FIG. 5(a); and FIG. 5(d) is a cross-sectional view taken along line Vd-Vd of FIG. 5(a).

In the lattice-shaped barrier ribs 29 according to the present embodiment, a portion having a thick barrier-rib width is formed on each of the barrier ribs 29b in the column direction that separate the R cells. In other words, the barrier rib 29b in the column direction that separates the R cell and the B cell is made thicker so that the area of the R cell is made small. The barrier-rib width of each of the barrier ribs 29a in the row direction is constant without any portion having a thick barrier-rib width.

The cell areas are made to have the same size with respect to the G cell area and the B cell area; however, the R cell area is made narrower on the left side of the figures, in comparison with the G cell area and the B cell area. In the same manner as in the first embodiment, in this structure also, although the discharge space in the R cell becomes smaller, no adverse effect is given on full color display because the red phosphor has a better luminosity factor.

In this manner, by making thicker the width of the barrier ribs in the row direction that separate the R cells, the height of the corresponding portion of the barrier rib is made lower through shrinkage during firing.

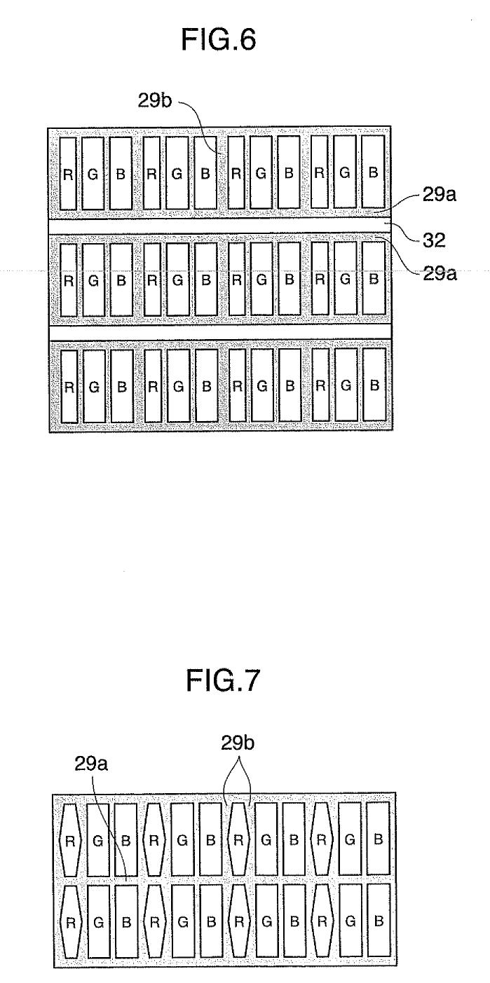

FIG. 6 is an explanatory diagram that shows a third embodiment of the barrier ribs according to the present invention. This figure shows a state in which barrier ribs are viewed from above.

This embodiment is a modified example of the second embodiment, and with respect to lattice-shaped barrier ribs 29, a portion having a thick barrier-rib width is formed on each of the barrier ribs 29b in the column direction that separate the R cells. The barrier-rib width of each of the barrier ribs 29a in the row direction is constant without any portion having a thick barrier-rib width.

The cell areas are made to have the same size with respect to the G cell area and the B cell area; however, the R cell area is made narrower on the left side of the figures, in comparison with the G cell area and the B cell area. In the same manner as in the first embodiment, in this structure also, although the discharge space in the R cell becomes smaller, no adverse effect is given on full color display because the red phosphor has a minimum luminosity factor.

With respect to the barrier ribs 29 that have a lattice pattern, the barrier ribs 29a in the row direction are separated in the column direction, and a vent path 32 is formed through the portions at which the barrier ribs 29a are separated. With this arrangement, it becomes possible to increase the ventilation conductance in the row direction.

FIG. 7 is an explanatory diagram that shows a fourth embodiment of the barrier ribs according to the present invention. This figure shows a state in which barrier ribs are viewed from above.

This embodiment is also a modified example of the second embodiment, and with respect to lattice-shaped barrier ribs 29, a portion having a thick barrier-rib width is formed on each of the barrier ribs 29b in the column direction that separate the R cells. This portion having the thick barrier-rib width has its width varied so as to form the R cell area into a lozenge shape. The barrier-rib width of each of the barrier ribs 29a in the row direction is constant without any portion having a thick barrier-rib width.

The cell areas are made to have the same size with respect to the G cell area and the B cell area; however, the R cell area is made smaller in comparison with the G cell area and the B cell area. In the same manner as in the first embodiment, in this structure also, although the discharge space in the R cell becomes smaller, no adverse effect is given on full color display because the red phosphor has a minimum luminosity factor. In this manner, the shape of the cells may be formed into a desired shape.

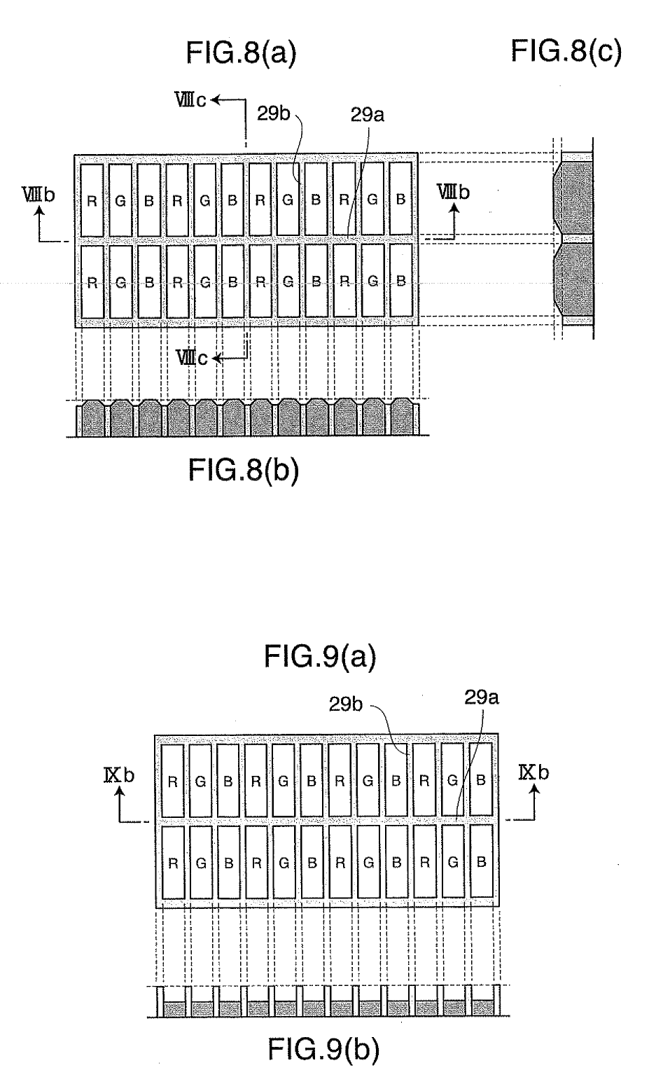

FIGS. 8(a) to 8(c) are explanatory diagrams that show a first comparative example. FIG. 8(a) shows a state in which barrier ribs are viewed from above; FIG. 8(b) is a cross-sectional view taken along line VIIIb-VIIIb of FIG. 8(a); and FIG. 8(c) is a cross-sectional view taken along line VIIIc-VIIIc of FIG. 8(a).

Lattice-shaped barrier ribs 29 formed by barrier ribs 29a in the row direction and barrier ribs 29b in the column direction are formed in this comparative example; however, no portion having a thick barrier-rib width is formed in the lattice-shaped barrier ribs 29.

Therefore, even when the patterned barrier-rib shaped layer is fired, the heights of the barrier ribs are not made irregular due to thermal shrinkage during firing; consequently, it becomes difficult to ensure a vent path used during sealing the substrates.

FIGS. 9(a) and 9(b) are explanatory diagrams that show a second comparative example. FIG. 9(a) shows a state in which barrier ribs are viewed from above, and FIG. 9(b) is a cross-sectional view taken along line IXb-IXb of FIG. 9(a).

Although the structure in this comparative example is the same as that of the first comparative example, when viewed from above, the barrier ribs 29a in the row direction have a height lower than that of the barrier ribs 29b in the column direction. Although this structure increases the ventilation conductance in the column direction, complex manufacturing processes are required to form the barrier ribs of this structure.

In comparison with these comparative examples, in the barrier-rib structures of the embodiments according to the present invention, barrier rib portions used for separating R cells are made lower by forming the width of those barrier ribs wider, through thermal shrinkage during firing the barrier ribs. In general the crossing portion of the barrier ribs has a symmetrical shape with respect to the center of the crossing portion, when viewed from above; however, in the case where the symmetric state is disordered, since the tensile stress to be imposed during thermal shrinkage comes to have an asymmetric property, the difference in height of the barrier ribs is made greater. With this arrangement, it is possible to improve the exhausting process inside the panel and the injecting process of a discharge gas into the panel in a PDP having the closed-type barrier-rib structure by using a simple structure, and consequently to improve the quality of the PDP.

What is claimed is:

1. A plasma display panel comprising:
a pair of substrates forming a discharge space therebetween;
barrier ribs in a row direction and a column direction that divide the discharge space into the row direction and the column direction to form discharge cells in a matrix pattern; and
phosphor layers of three colors of red, green and blue formed inside the discharge cells to provide different colors through repetitive patterns and also to have the same color in the discharge cells in the column direction,
wherein the width of barrier ribs that divide discharge cells having a red phosphor layer whose luminosity factor is the smallest is made wider than that of barrier ribs that divide discharge cells of the other colors so that the height of the barrier ribs is made lower.

2. The plasma display panel according to claim 1, wherein the barrier ribs, used for dividing discharge cells of a red color, that have a wider width with a low height are barrier ribs in the row direction.

3. The plasma display panel according to claim 1, wherein the barrier ribs, used for dividing discharge cells of a red color, that have a wider width with a low height are barrier ribs in the column direction.

4. The plasma display panel according to claim 1, wherein the barrier ribs, used for dividing discharge cells of a red color, that have a wider width with a low height are barrier ribs, in the column direction, having the width varied so as to form the area of the red color cell into a lozenge shape.

5. A method of forming a barrier rib in a plasma display panel comprising the steps of:
forming a material layer for barrier ribs on one of substrates;
patterning the material layer for barrier ribs into a barrier-rib shape of a closed type in which a discharge space is divided into R cells used for forming a red phosphor layer, G cells used for forming a green phosphor layer, and B cells used for forming a blue phosphor layer;
at the time of the patterning, forming a barrier-rib shaped layer having a pattern in which the width of barrier ribs in the row direction or barrier ribs in the column direction used for separating the R cells is wider than the width of barrier ribs used for separating the cells of the other colors so as to generate an irregularity in the height of the barrier ribs in the row direction or the barrier ribs in the column direction used for separating the R cells through thermal shrinkage during firing; and
firing the patterned barrier-rib shaped layer so that barrier ribs of a closed type in which barrier ribs in the row direction or barrier ribs in the column direction used for separating the R cells are allowed to have a height lower than the height of the barrier ribs used for separating the G cells and the B cells are formed.
